(19) United States
(12) Patent Application Publication
(10) Pub. No.: US 2013/0256540 A1
(43) Pub. Date: Oct. 3, 2013

(54) ACCELERATOR BEAM MONITORING DETECTOR AND READOUT DEVICE THEREOF

(71) Applicants: ACADEMIA SINICA, Taipei City (TW); NATIONAL CENTRAL UNIVERSITY, Jhongli City (TW); NATIONAL UNITED UNIVERSITY, Miaoli (TW)

(72) Inventors: PING-KUN TENG, New Taipei City (TW); AUGUSTINE EI-FANG CHEN, Taichung City (TW); MING-LEE CHU, Xizhi City (TW); CHIH-HSUN LIN, Taipei City (TW); CHUNG-HSIANG WANG, Miaoli (TW)

(73) Assignees: Academia Sinica, Taipei City (TW); National United University, Miaoli (TW); National Central University, Jhongli City (TW)

(21) Appl. No.: 13/850,853

(22) Filed: Mar. 26, 2013

(30) Foreign Application Priority Data
Mar. 27, 2012 (TW) 101110517

(51) Int. Cl. H01J 47/00

(52) U.S. Cl. CPC H01J 47/001
USPC 250/370.01; 250/336.1; 250/394; 250/389

(57) ABSTRACT

The present invention provides a readout device of an accelerator beam monitoring detector, comprising: a transimpedance amplifier receiving a charge signal from a particle detector and converting the charge signal into an analog voltage signal; and a data acquisition system comprising an analog-to-digital converter (ADC) to covert the analog voltage signal into digital data.

### BACKGROUND OF THE INVENTION

1. Field of the Invention

The present invention relates to a beam monitoring detector used in accelerators, and more particularly, to a readout device of a beam monitoring detector.

2. Description of the Prior Art

During accelerator operation, measuring the distributions of beam intensities is essential for controlling the delivered radiation dosage. When an accelerator is used for radiation therapy, it is necessary to take full control of the distributions of particle beam intensities before and during the radiation treatment, so as to ensure that exact dosages are delivered to the desired parts of a patient. Please refer to FIG. 1. FIG. 1 shows respective architectures of readout devices of a single-channel and a multi-channel beam monitoring detectors for accelerators. A readout device 100 of a single-channel accelerator beam monitoring detector generally comprises three units: a particle detector 101, a detector front-end circuit 102, and a data acquisition system 103. The particle detector 101 converts part of the particle energy into a current signal. The detector front-end circuit 102 amplifies and processes the current signal converted by the particle detector 101. The data acquisition system 103 then converts the signal processed by the detector front-end circuit 102 into digital data for further processing. Another readout device 110, as shown in the figure, works on a multi-channel accelerator beam monitoring detector to directly measure the distribution of the particle beam intensities; the design of this readout device is basically integrating a plurality of single-channel systems to constitute one multi-channel system.

FIG. 2 shows an architecture of a conventional readout device of a single-channel beam monitoring detector. Referring to both FIG. 1 and FIG. 2, a conventional single-channel beam monitoring detector generally uses a charge integrating circuit as the front-end circuit of a detector. Charge signals collected by the particle detector are sent to a charge integrating circuit 210 through an input terminal 200. The charge integrating circuit 210, comprising an amplifier 211 and a feedback capacitor 212, converts the accumulated charge signals into voltage signals. When there are continuous currents passing the circuit during operation, the charge integrating circuit 210 needs to discharge if the amount of charge reaches an integration upper limit. The charge integrating circuit 210 further comprises a discharge circuit 213 and a voltage comparator 214 to perform the discharging operation. The voltage comparator 214 detects the voltage signals output from the charge integrating circuit 210, and when the output voltage exceeds a predetermined voltage limit 215, the voltage comparator 214 will output a pulse signal. The pulse signal activates the discharge circuit 213 to reset the charge integrating circuit 210; on the other hand, the pulse signal is sent to a data acquisition system 220. The data acquisition system comprises a counter 221, a time measurement device 222 and may further comprise other necessary components. When the amount of the collected charge increases, the count value of the counter 221 increases accordingly. The amount of charge which one count represents is determined by the capacitance value of the feedback capacitor 212 and the predetermined voltage limit set for the voltage comparator 214. The time measurement device included in the data acquisition system 220 allows average current to be calculated in a specified time period. The architecture of a conventional beam monitoring detector that uses a charge integrating circuit is advantageous in minimizing problems caused by amplifier noise or bias current; thus, this kind of architecture is capable of detecting even smaller signals from a particle detector and is useful for beam monitoring detectors with single channel or very few channels, such as Faraday cup detectors used for detecting the number of ions in an ion beam.

However, an integrating circuit is composed of many different components, and the number of components will multiply when increasing the number of channels of a circuit, thereby consuming a much larger area on a circuit board. In particular, when a multi-channel beam monitoring detector consisting of a two-dimensional array of integrating circuits is to be developed, it will require a very large circuit board size. Therefore, a custom readout integration circuit chip is needed to be developed in order to reduce the board size requirement, which can be rather costly. In addition, a readout device using conventional integrating circuit architecture cannot measure the change of beam conditions within the period of integration.

As such, there exists a need for an advanced accelerator beam monitoring detector and its readout device, which require low production cost, low development cost and are small in size and easy to maintain, so that building a beam monitoring system having thousands of channels on a circuit board of a reasonable size can be easily achieved.

### SUMMARY OF THE INVENTION

An object of the present invention is to provide an accelerator beam monitoring detector and its readout device, which require low production cost, low development cost and are small in size and easy to maintain, so that building a beam monitoring system having thousands of channels on a circuit board of a reasonable size can be easily achieved.

To achieve the above object, the present invention provides a readout device of an accelerator beam monitoring detector, comprising: a transimpedance amplifier receiving a charge signal from a particle detector and converting the charge signal into an analog voltage signal; and a data acquisition system comprising an analog-to-digital converter (ADC) to covert the analog voltage signal into digital data.

In the aforementioned readout device, a feedback resistor of the transimpedance amplifier can be replaceable so that the sensitivity range of beam monitoring detector can be adjusted according to the need of for different applications.

In the aforementioned readout device, the beam monitoring detector is a proton beam monitoring detector, an ion beam monitoring detector, or an electron beam monitoring detector.

In the aforementioned readout device, the particle detector is an ionization-type detector.

In the aforementioned readout device, the ionization-type detector is a semiconductor detector, an ionization chamber, or a calorimeter using multiple copper foil layers.

To achieve the above object, the present invention further provides a multi-channel accelerator beam monitoring detector comprising a plurality of readout devices, each readout device comprising: a transimpedance amplifier receiving a charge signal from a particle detector and converting the charge signal into an analog voltage signal; and a data acquisition system comprising an analog-to-digital converter (ADC) to covert the analog voltage signal into digital data.

Moreover, the aforementioned multi-channel accelerator beam monitoring detector has more than 20 channels.

### BRIEF DESCRIPTION OF THE DRAWINGS

FIG. 1 shows respective architectures of readout devices for a single-channel and a multi-channel beam monitoring detectors for accelerators.

FIG. 2 shows an architecture of a conventional readout device of a single-channel accelerator beam monitoring detector.

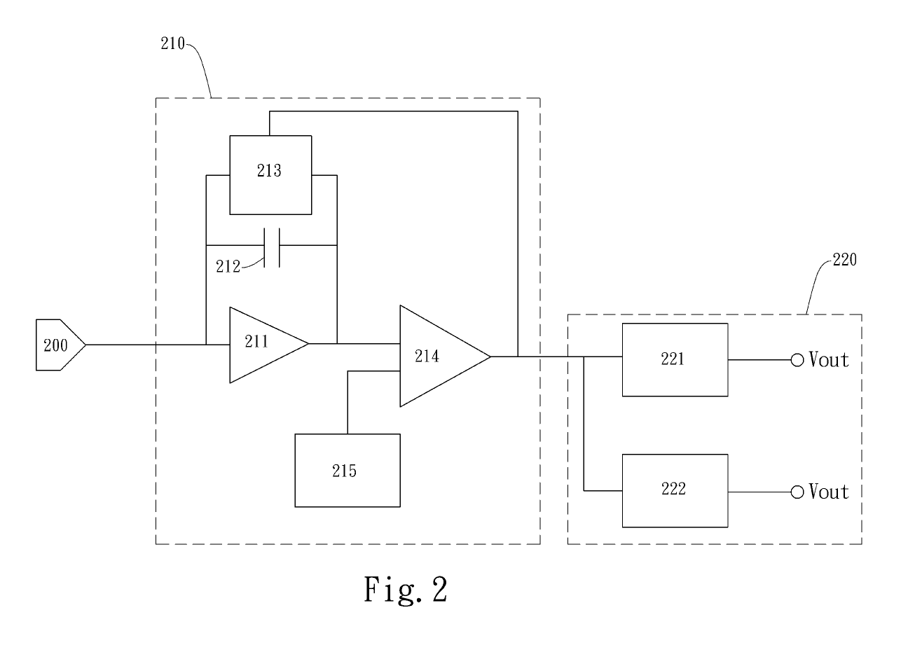

FIG. 3 shows an architecture of a readout device of an accelerator beam monitoring detector according to an embodiment of the present invention.

### DETAILED DESCRIPTION OF THE PREFERRED EMBODIMENTS

The detailed embodiments of the present invention will be provided in the following paragraphs. It is to be noted that the embodiments of the present invention are exemplary. The present invention is not limited to the embodiments comprising specific features, structures or properties and the scope thereof is defined by the appended claims. In addition, the drawings do not specifically illustrate all unnecessary features of the present invention. For those illustrated in the drawings, they may be represented in simplified form or schematic manner. Furthermore, for the sake of clarity, the sizes of the components may be magnified in the drawings or not in actual proportion. Whether or not the components are simplified in form or the features are illustrated in detail, they fall within the scope of knowledge of the art so that they can be implemented by those skilled in the art in view of other embodiments related to the features, structures or properties.

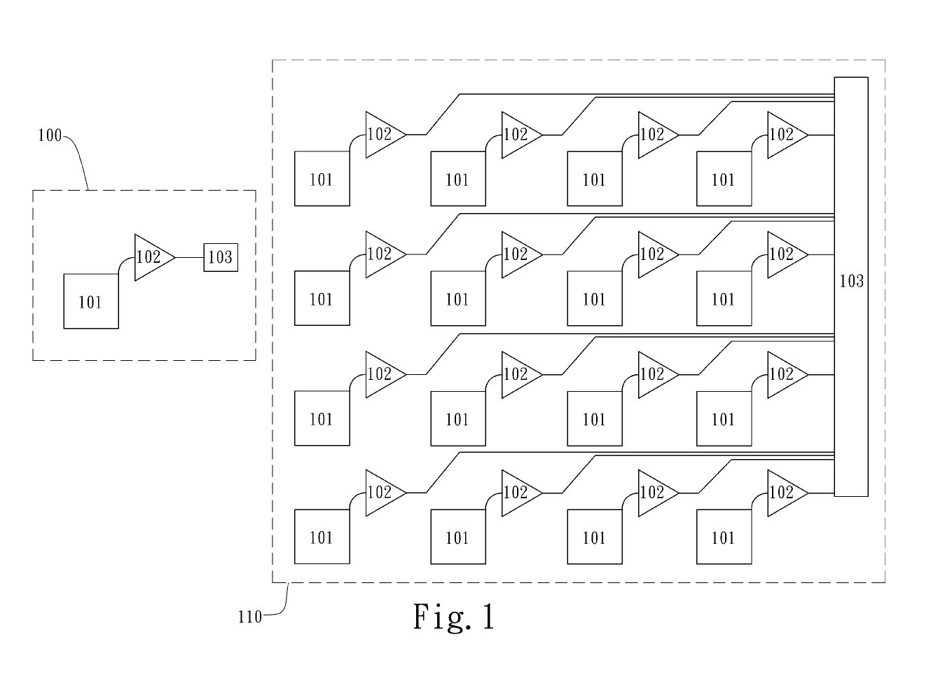

The present invention uses a transimpedance amplifier to form the detector front-end circuit as illustrated in FIG. 1. The transimpedance amplifier amplifies signals of slight electric currents from a detector, and converts the signals into measurable voltage signals which can be recorded through ordinary voltage measurement means. The composition of a transimpedance amplifier requires only one operational amplifier and very few resistors and capacitors. By reducing the number of electronic components used for a single channel, one can build a beam monitoring system having a large number of channels, yet the complexity, area and production cost of the system will not necessarily increase to a great extent. Only one transimpedance amplifier is needed for a single channel in a beam monitoring detector's readout device. Therefore, it will be easier to realize a multi-channel accelerator beam monitoring detector with a smaller size and lower cost.

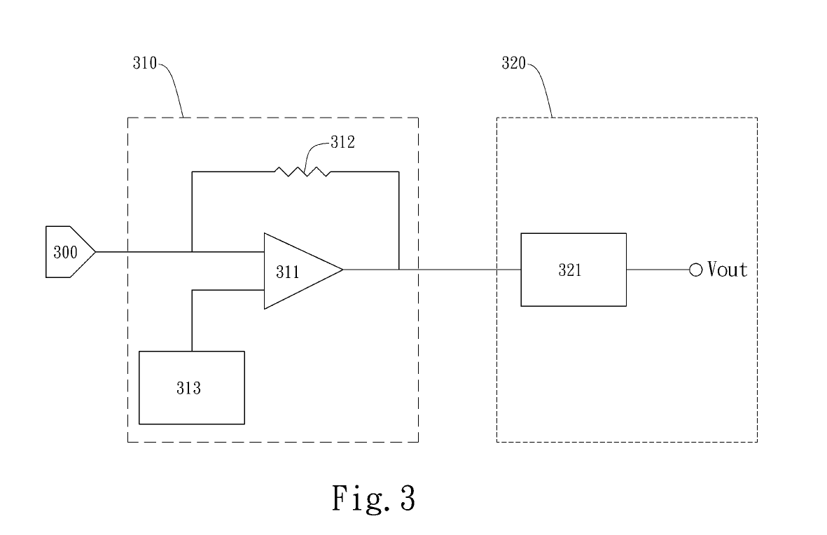

FIG. 3 shows an architecture of a readout device of an accelerator beam monitoring detector according to an embodiment of the present invention. The readout device of the present invention comprises a transimpedance amplifier 310 and a data acquisition system 320. The transimpedance amplifier 310 comprises an operational amplifier 311 and a feedback resistor 312. An offset voltage terminal 310 of the transimpedance amplifier is used for setting an output offset voltage when no current is input. Optionally, the feedback resistor 312 may connect to a capacitor (not shown) in parallel to filter external electro-magnetic interference or the internal AC noise. An input terminal of the transimpedance amplifier 310 receives a charge signal from a particle detector (not shown) and converts the charge signal into an analog voltage signal for output. The increase or decrease in the output of analog voltage signals from the transimpedance amplifier 310 (i.e. output voltage) depends on the polarity and magnitude of the charge signals received (i.e. input current). The analog voltage signal output from the transimpedance amplifier 310 is sent to an analog-to-digital converter (ADC) 321 in the data acquisition system 320. The ADC 321 converts the analog voltage signal into digital data for further display, record or analysis purpose.

The basic electronic components used in the present invention, such as the operational amplifier and the ADC, are low-price standardized products available on the market of electronics industries. Moreover, in an embodiment of the present invention, the beam monitoring detector may be a proton beam monitoring detector, an ion beam monitoring detector, or an electron beam monitoring detector; the particle detector may be an ionization-type detector, including but not limited to a semiconductor detector, an ionization chamber, or a calorimeter using multiple copper foil layers. In addition, the sensitivity of the transimpedance amplifier 310 regarding the output voltage and output current is determined by the feedback resistor 312. In one embodiment of the present invention, if the feedback resistor 312 is 100M ohms and the ADC 321 has a 1 digit sensitivity of ±1 mV, then the minimum measured current is 1 mV/100M ohms=10 A. To achieve the minimum measured current in this example, the operational amplifier 311 needs to have a bias current lower than 10 pA and an input offset voltage lower than 1 mV. The feedback resistor 312 used in the present invention can be replaced, so to adjust the sensitivity range according to the need of different applications.

A prototype circuitry according to the present invention has been developed, and the specifications are given briefly as follows. The circuitry is composed of a front-end circuit board a master control board. The front-end circuit board is 12.5 cm long and 3.1 cm wide. A 64-channel transimpedance amplifier and a 64-channel ADC are mounted on the front-end circuit board; the sensitivity of each transimpedance amplifier is uniformly set by replacing all 64 resistors on a single resistor board. The master control board is 17.5 cm long and 14 cm wide; it can have four front-end circuit boards mounted thereon to provide them with power and other control and communication functions as necessary. The four front-end circuit boards constitute a readout device of a 256-channel beam monitoring detector, and the acquired data are sent to a computer through the master control board. Thus, when any multi-channel particle detector (such as semiconductor detector, ionization chamber, or calorimeter using multiple copper foil layers) is connected to the above front-end circuit boards through a connector, a complete accelerator beam monitoring detector is formed. The above prototype circuitry has been tested on the following particle detectors to form beam monitoring detector systems: a 256-channel two-dimensional beam monitoring system with an ionization chamber having 16×16 channels; a pseudo two-dimensional high-resolution accelerator beam monitoring system with a long-strips ionization chamber having 64 horizontal and 64 vertical channels; an accelerator calorimeter system with a 64-channel multi-layer ionization chamber; and a 64-channel multi-layer, current-measuring accelerator calorimeter system.

The spirit and scope of the present invention are not limited to the aforementioned embodiments. In addition, it will be understood that the drawings are merely schematic representations of the invention and not illustrated according to actual scale, and some of the components may have been magnified or simplified for purposes of pictorial clarity. The embodiments depicted above and the appended drawings are exemplary and are not intended to limit the scope of the present invention. The scope thereof is defined by the appended claims.

What is claimed is:

1. A readout device of an accelerator beam monitoring detector, comprising:
a transimpedance amplifier receiving a charge signal from a particle detector and converting the charge signal into an analog voltage signal; and
a data acquisition system comprising an analog-to-digital converter (ADC) to covert the analog voltage signal into digital data.

2. The readout device according to claim 1, wherein a feedback resistor of the transimpedance amplifier is replaceable so to adjust the sensitivity range according to the need of different applications.

3. The readout device according to claim 1, wherein the beam monitoring detector is a proton beam monitoring detector, or an ion beam monitoring detector, an electron beam monitoring detector.

4. The readout device according to claim 1, wherein the particle detector is an ionization-type detector.

5. The readout device according to claim 4, wherein the ionization-type detector is a semiconductor detector, an ionization chamber, or a calorimeter using multiple copper foil layers.

6. A multi-channel accelerator beam monitoring detector, comprising:
a plurality of readout devices, each readout device comprising
a transimpedance amplifier receiving a charge signal from a particle detector and converting the charge signal into an analog voltage signal; and
a data acquisition system comprising an analog-to-digital converter (ADC) to covert the analog voltage signal into digital data.

7. The multi-channel accelerator beam monitoring detector according to claim 6, wherein the multi-channel beam monitoring detector has more than 20 channels.

8. The multi-channel accelerator beam monitoring detector according to claim 6, wherein a feedback resistor of the transimpedance amplifier is adjustable so that the beam monitoring detector can be used for different applications.

9. The multi-channel accelerator beam monitoring detector according to claim 6, wherein the beam monitoring detector is a proton beam monitoring detector, an ion beam monitoring detector, or an electron beam monitoring detector.

10. The multi-channel accelerator beam monitoring detector according to claim 6, wherein the particle detector is an ionization-type detector.

11. The multi-channel accelerator beam monitoring detector according to claim 10, wherein the ionization-type detector is a semiconductor detector, an ionization chamber, or a calorimeter using multiple copper foil layers.
